(19) United States
(12) Patent Application Publication
(10) Pub. No.: US 2002/0095301 A1
(43) Pub. Date: Jul. 18, 2002

(54) Load sharing

(76) Inventor: Jose Villena, Miami, FL (US)

Correspondence Address: KAPLAN & GILMAN , L.L.P., 900NROUTE 9 NORTH, WOODBRIDGE, NJ, 07095, US

(21) Appl. No.: 09/764,030

(22) Filed: Jan. 17, 2001

(51) Int. Cl. G06F 17/60

(52) U.S. Cl. 705/1

(57) ABSTRACT

An improved technique of interfacing with databases and other information sources is disclosed. A set of transaction switches evaluates particular transactions to determine the type, quantity, and other parameters associated with information access. The transaction switches then spread the transactions across multiple transaction engines, in a manner such that equal processing load is placed upon the transaction engines. The transaction engines then interface directly with information sources, such as databases.

### TECHNICAL FIELD

This invention relates to resource allocation, and more specifically, to an improved method and apparatus for balancing the loading created by various computer transactions that require database and other resource access. The invention is particularly useful in the deployment of contact centers, where large numbers of transactions are performed by customers and/or other users contacting agents or customer representatives for a business. Further, the invention is also of particular use in the repeated querying of databases in order to alleviate excessive loading on the system.

### BACKGROUND OF THE INVENTION

Database accesses, particularly in contact centers, often require large amounts of resources and represent a bottleneck in a system. Usually, such systems operate using a client server model. The client server model is shown conceptually in FIG. 1. Client software applications utilize various databases to retrieve information required for processing various contacts.

More specifically, various contacts are received from network 110 through switch 113. Such contacts may be from customers reporting particular problems, seeking information, requesting service, etc. The network 110 may be the Public Switched Telephone Network (PSTN), the Internet, a private network, etc. In servicing such requests, databases stored on any of exemplary servers 103-105 may need to be accessed in order to retrieve account records, ordering information, etc. In furtherance thereof, an exemplary client 101 simply issues requests for information from the appropriate databases using a well known client server model, and the information is provided via the local area network (LAN) 102.

One problem with the foregoing arrangement is that there is typically little or no management of the loads being placed upon servers 103 through 105 by clients 101 and 111. In a real system, where there are a large number of such clients and databases, the failure to properly manage the loading of the network and the various servers can result in severely degraded performance. Additionally, different applications running within the same client computer may also place different loads on different servers with little coordination. This also degrades system performance.

In view of the above, there exists a need in the art for an improved method and apparatus to perform load balancing when plural data access inquiries to various servers are required.

There also exists a need for a fault tolerant system that balances the loading of the various servers.

### SUMMARY OF THE INVENTION

The above and other problems of the prior art are overcome and a technical advance is achieved in accordance with a novel load balancing architecture for servicing plural queries and other data accesses, and for distributing the load created by the plural accesses to various databases. The architecture has particular application in the implementation of contact centers, where a large number of inquiries and other data access transactions to numerous databases are required on an ongoing and continual basis. More specifically, the invention provides a technique to balance across all processing resources transactions being processed by various client applications that involve continuous and repeated access to databases.

In accordance with the invention, a plurality of transaction switches are utilized in order to distribute transactions across a plurality of transaction engines. The transactions switches isolate the client applications from the database itself, and the transaction engines interface directly with the one or more databases required to implement the transaction.

Before assigning particular transactions to a particular transaction engine, the transaction switch calculates (1) how many units of additional loading that will be placed upon the transaction engine and optionally (2) how much additional loading will be placed upon connections between the transaction engines and the various databases. Such calculation is arrived at by taking into account information about the particular transaction in question. Upon calculating the particular loading, the transaction switch then assigns the transactions to different transaction engines in a manner such that the loading of the transaction engines is balanced. Thus, if a client application requests information that requires access to plural databases, the transaction switch will take this into account, view the transaction as “expensive” and then assign it accordingly in order to keep the load across the plural transactions engines substantially balanced.

In an enhanced embodiment, each client is connected to at least one main transaction switch and at least one backup transaction switch. Additionally, each transaction switch assigns a transaction to a primary transaction engine and a backup transaction engine. Accordingly, the system provides redundancy with respect to both the transaction engines and the transaction switches, and indeed at each link from the client application to the actual database being accessed.

### BRIEF DESCRIPTION OF THE DRAWINGS

FIG. 1 depicts a prior art contact center arrangement including a switch, plural servers and clients, and a network;

FIG. 2 depicts conceptual diagram of an exemplary embodiment of the present invention; and

FIG. 3 indicates an exemplary embodiment of the present invention showing an example network configuration implementing the present invention.

### DETAILED DESCRIPTION OF THE PREFERRED EMBODIMENT

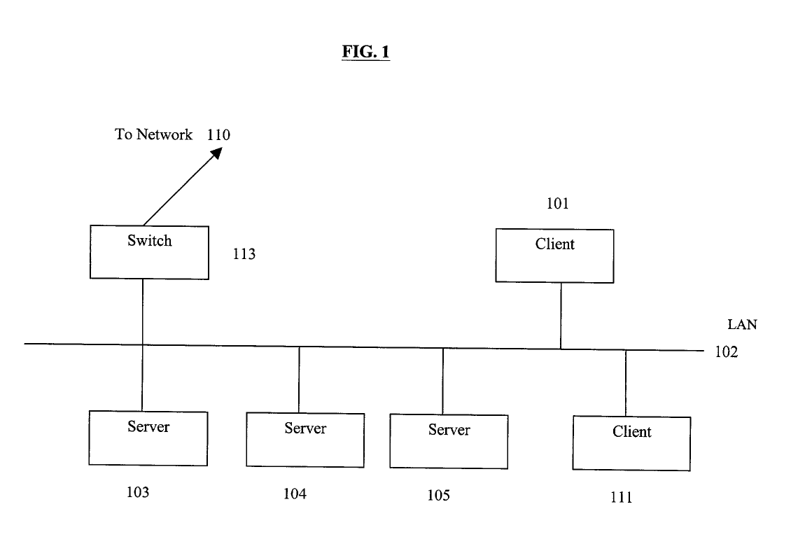

FIG. 1 depicts a typical network for implementing a contact center. The arrangement of FIG. 1 includes a switch 113 for routing contacts to and from the public network to local area network (LAN) 102. The system of FIG. 1 uses a conventional prior art logical architecture known as client server, as described above. The public network may be a public switched telephone network (PSTN) or a data network such as the Internet, or a combination of both as well as other types of networks.

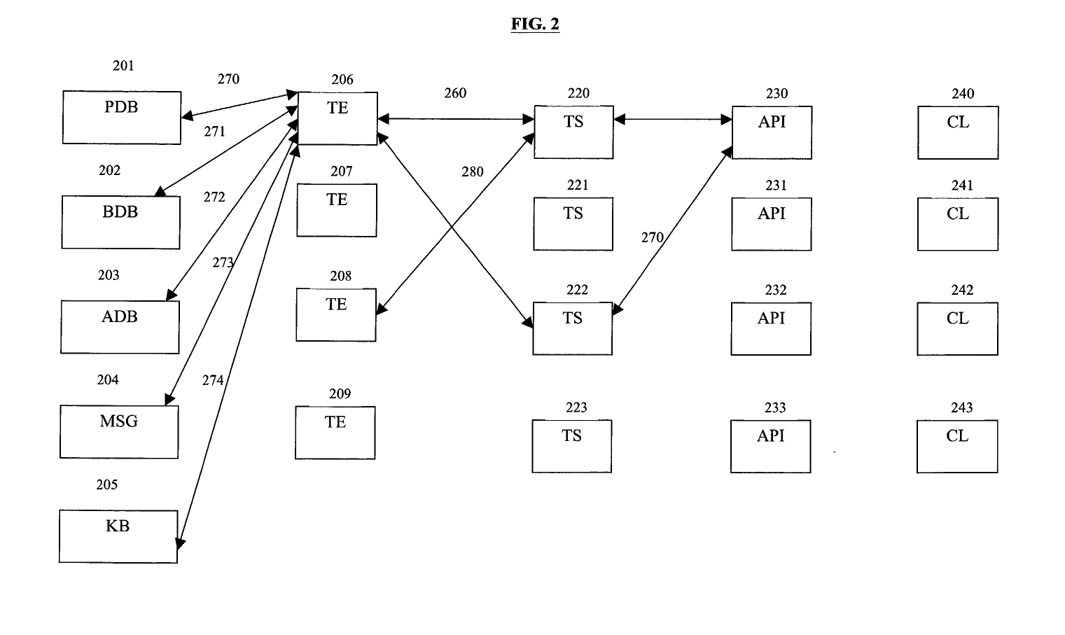

FIG. 2 shows a functional diagram of an architecture that implements an exemplary embodiment of the present invention. The arrangement of FIG. 2 comprises plural clients 240 through 243, each of which includes an associated applications programming interface (API) 230 through 233. A plurality of transaction switches 220 through 223 are shown, each of which may preferably be accessed by any one or more of clients 240 through 243. Transaction engines 206 through 209 directly interface with the variety of stored information 201 through 205 and interface between the transaction switches 220 to 223 and clients 240 to 243, and the stored information 201 to 205.

Clients 240 to 243 may represent a variety of client applications. In a contact center, the applications may include items such as agent desktop, supervisor desktop, and call center manager configuration application. The client applications 240 through 243 may be resident on a single or plural hardware platforms. Such applications may be tailored to a specific customer's needs at a specific contact center, such as an airline, a credit card company, etc.

Transaction switches 220-223 provide a standard interface to APIs 220-230 as shown in FIG. 2. Although only two communications links 250 and 270 are shown between the APIs and the transaction switches, it is understood that many sets of such connections would be present in an actual system. In general, the transaction switches are the computers that accept requested transactions from APIs 230-233 and determine through which transaction engine 206-209 the transaction should be processed. Preferably, the transaction switches 220-223 determine to which transaction engine the transaction should be assigned by ascertaining the particular amount of loading that such a transaction requires on a transaction engine and its connections to the various databases 201-205, and distributing that loading in an evenly as possible manner.

For example, consider a transaction that requests that a particular email arriving from a customer and containing a question be answered. Such a transaction would require access to a data base that stores the answers (e.g. 205, described more fully below) and access to a database that stores the list of arriving questions from customers (e.g. 204, described more fully below). Transaction switch 220 has the required intelligence to ascertain that such a requested transaction from API 230 would require queries into two different databases, one to obtain the next customer question in the queue, and another to retrieve the answer from a knowledge database 205.

As shown in FIG. 2, the system also includes the plurality of transaction engines 206-209. The transaction engines separate out the different queries and database accesses required for a particular transaction, and interface directly with one or more databases. Notably, due to the API isolating the client from the transaction switch and the transaction engines, the client application needs no knowledge of where any data is stored, or whether all data for a transaction is stored on a single computer or multiple computers. Rather, the API may be used to write applications, and the API instructs the transaction switches to process the request.

Once a transaction is assigned to a particular transaction engine, the various database accesses that such a transaction engine may require are separated by the transaction engine, performed, and the result of the transaction then passed pack to the transaction switch. In general then, the transaction engine is defined as the entity that accepts the transaction, involving one or more database accesses, performs the transaction in however many accesses and queries are required, and then passes back the result to the transaction switch that assigned the transaction to the transaction engine. In the preferred embodiment, the transaction engine has no knowledge of the particular client application 240-243 requesting the transaction, and the client 240-243 has no knowledge of the particular transaction engine performing the transaction.

The transaction engines have particular knowledge of the location of the appropriate data required for the transaction, and also know which particular data accesses are required to complete the transaction. Thus, the details of the database queries and accesses are isolated from the client application.

Database 201 is the primary database. Primary database will include information such as call state information (e.g. trunk 231 connected via gateway port 17 to agent 36), call queue information (for service A, caller on trunk 14 and associated data—DNIS, ANI, etc. —is first in queue; caller on trunk 93 is second in queue, etc.), call detail information—call came from where (DNIS), on hold how long, sent to which agent, there how long, disposition. A backup database 202 remains in full synchronization with the primary database 201 and provides for immediate switchover in the event of a failure of the primary database 201. Thus, any failure of a primary database will be essentially unnoticed by client applications.

An archive database 203 contains archive backups periodically, for example, every five (5) days. While the archive may be used in an emergency to provide some service, the archive database is not necessarily kept synchronized with either the primary database or the backup database, so that information between a most recent archive and a present state of the system is not included in the archive database. Such an arrangement strikes a balance between the processing costs of keeping three databases synchronized, which would be prohibitive, and the benefit of having some backup, which is provided by the real time synchronized backup of backup database 202, and the archived, periodically updated database 203.

A message database 204 includes a queue of incoming messages received via e-mail, which messages are serviced by an appropriate one of clients 240 through 243. Applications running on any of clients 240 through 243 may service the emails in the database 204 utilizing any of a variety of techniques. For example, software is available that attempts to recognize that a particular text message, such as an email, is asking a particular question. Such software utilizes natural language recognition techniques. The software may match particular incoming emails to prestored questions and answers, so that answers may be automatically transmitted back to a customer.

Finally, a knowledge database 205 includes any relevant knowledge required by any one of clients 240 through 243. In addition to the foregoing example of frequently asked questions and answers, the knowledge database may include items such as password information to authenticate users, weather forecasts to be used by applications providing such data to customers, or any other possible requested information. Each of the databases 201 through 205 may be updated periodically, whenever transactions change the content of such databases, or a combination of both.

In operation, an exemplary client 240 receives a contact to be processed. Depending upon the particular application running on client 240, the contact may require access to one or more databases 201 through 205. The API 230 connects client 240 over communications links 250 and 270 with a primary transaction switch 220 and a backup transaction switch 222. The backup transaction switch 222 will operate as a hot spare, providing a path from API 230 to the transaction engine 206 in the event of a failure of either transaction switch 220 or communications line 250.

Once the communications links 250 and 270 are established, and the transaction switches 220 and 222 are selected as the primary and backup transaction switches respectively, the transaction is processed to parse from it the information indicative of the loading that such a transaction will place on the system of transaction engines 206-209 and the databases 201-205. Additionally, the transaction switch 220 may also be capable of ascertaining the loading that the transaction will place upon the database links 270-274. Optionally, the transaction may be assigned a priority, which will also be taken into account in that higher priority transactions will be assigned an increased loading factor. This means that transaction engines assigned higher priority transactions will be considered more loaded, and will be eligible to receive less other transactions, thereby allowing such transaction engines to more readily service the higher priority transactions.

Regardless of the formula used to arrive at a loading factor, the transaction switch assigns a particular such loading factor to the transaction. Also, during steady state operation of the system, the various transaction engines repeatedly publish their respective loads. Thus, for example, each transaction engine may, immediately after being assigned any new transaction and/or immediately after completing processing of any transaction, broadcast its present state of loading to all of the transaction switches 220-223 over a network. Alternatively, the transaction engines may publish their respective loading at predetermined times. This provides that all transaction switches will have the present state, to within a reasonable degree of certainty, of loading of all transaction engines, and can thus assign the transactions in order to balance the loading as described above.

Different algorithms for assigning a loading factor to each transaction may be used by the transaction switches. For example, the transaction switch may examine the estimated number of database accesses required for the particular transaction in question. Other parameters may include the amount of data required to be retrieved from any of databases 201 through 205, the mathematical processing, if any, required at transaction engine 206, the relative state of congestion of the various links 270-273, and any other desired factor. In its simplest form, the transactions may simply be assigned in a round robin fashion sequentially to the transaction engines.

In operation, the exemplary transaction switch 220 weighs the foregoing and other parameters and determines which of transaction engines 206 through 209 should be the primary transaction engine for processing the transaction. In the exemplary arrangement shown in FIG. 2, transaction engine 206 is chosen, and thus, a communication session is established over communication line 260.

Notably, both the connection from the API 230 to the transaction switch 220, and from the transaction switch 220 to the transaction engine 206 include backup. More specifically, communication line 250 is backed up by line 270, which connects to TS 222. Additionally, communication line 260 is backed up via communication line 280. Accordingly, a failure of either the transaction switch 220 or the transaction engine 206, or any of the communications therebetween, will remain effectively unnoticed by the client 240.

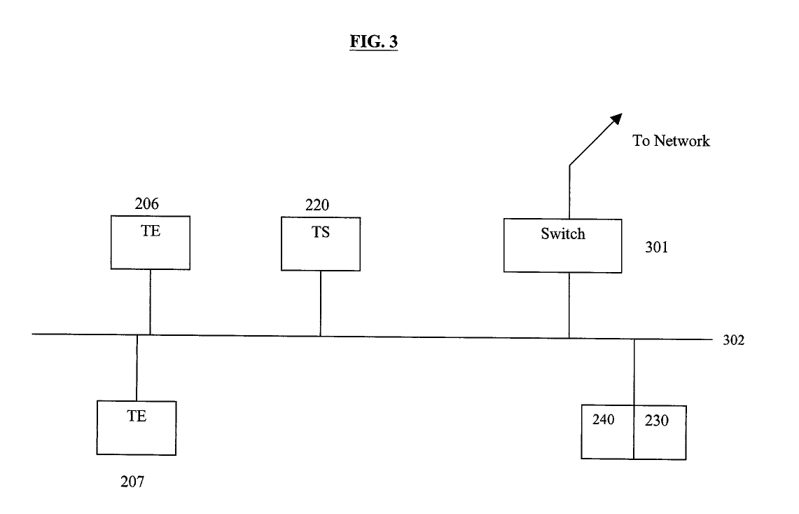

Transaction engine 206 is programmed with the specific breakdown of information required for a particular transaction from the numerous databases 201 through 205. Note that usually, when the system is in the fully operational state, databases 202 and 203 will not be used, since database 202 represents a backup database in the event of a failure of the primary database 201, and database 203 represents an archived database. Transaction engine 206 parses the particular transaction sent to it by transaction switch 220 and performs the appropriate interaction with the appropriate ones of databases 201 through 205. Such interaction may include items such as issue inquiries requested by the transaction, retrieving and storing data, obtaining records to be serviced, checking specific received information against knowledge contained within knowledge database 205, etc. Generally, the transaction engine is considered the basic interface into all of the databases, and thus isolation of the client applications from the databases is achieved FIG. 3 depicts a block diagram of an implementation of the logical arrangement of FIG. 2. Note that each of transaction engines 206 through 209, two of which are shown in FIG. 3, would operate preferably on a separate server connected to a network 302. Several other components, such as client 240 and transaction switch 220, are also shown in FIG. 3 for exemplary purposes. FIG. 3 does not show all of the components in FIG. 2, in order to keep the figure simple and clear enough for explanation purposes herein. The communications links 250 through 280 shown in FIG. 2 may actually be configured as packet communications between the appropriate terminals and servers as depicted in FIG. 3. Thus, many of the communications lines depicted in FIG. 2 may be virtual circuits of a packet network, although this is not necessarily required. Moreover, the connections of FIG. 2 may be between different networks entirely.

The client applications 240-243 may assign the transactions to any transaction switch 220-223. This system could simply assign each transaction from a client to the next transaction switch in a round robin fashion, or the client applications may assign their next transaction to the least loaded transaction switch. In such a case, the transaction switches would periodically publish to the client applications their respective loading. In any event, since the function of the transaction switches 220-223 is far less computationally intensive then the transaction engines 206-209, the load balancing function across transaction switches 220-223 is less critical than that across transaction engines 206-209.

By allowing for each transaction switch to balance the loads across transaction engines 206 through 209, the efficiency is maximized and all available capacity is used effectively. Moreover, the intelligence necessary to find the location of the data to be utilized by a transaction, and the particular database accesses required by each such transaction, is all determined by tables stored and software implemented in the transaction switches and transaction engines, not by the client applications themselves. Thus, the system is more user-friendly and convenient to a user.

While the above describes the preferred embodiment of the invention, various modifications will be apparent to those of skill in the art. The various components may be implemented on the same or different computers, or using remotely located or local servers. These and other variations are intended to be covered by the following claims.

What is claimed:

1. A system for processing transactions, each transaction requiring one or more database accesses, the system comprising plural client applications, plural transaction switches, and plural transaction engines, wherein client applications requiring transactions are configured to send a request for such transaction to a selected one of said transaction switches, wherein said selected transaction switch is configured to send said transaction to a selected transaction engine to perform said one or more database accesses, and wherein said transaction switch selects said transaction engine in a manner that attempts to balance loading across said transaction engines in a predetermined manner.

2. The system of claim 1 wherein said transaction switch is configured to determine how many database accesses are required, and to utilize such determination, at least in part, to assign said transaction to a transaction engine.

3. The system of claim 1 wherein said transaction switch is configured to determine a priority of said transaction, and to utilize said priority, at least in part, to assign said transaction to a transaction engine.

4. The system of claim 1 wherein said transaction switch is configured to determine bandwidth utilization of a communications link to a database, and to utilize said bandwidth utilization, at least in part, to assign said transaction to a transaction engine.

5. The system of claim 1 wherein said transaction switch utilizes at least two of bandwidth utilization to a database, priority, and number of database accesses required in order to assign the transaction to a transaction engine.

6. The system of claim 1 wherein each client application comprises software for selecting which transaction switch should be utilized to assign the transaction to a transaction engine.

7. The system of claim 6 connected to a contact center to process incoming or outgoing contacts.

8. A method of processing contacts at a contact center comprising the steps of:
establishing a communication session between a client application to process a transaction for said contact and a transaction switch;
determining a loading factor associated with said transaction;
based upon said loading factor, assigning said transaction to one of plural transaction engines to perform multiple database accesses in furtherance of said transaction, wherein said transaction switches do not communicate directly with said database, but said transaction engines do.

9. The method of claim 8 further comprising the step of broadcasting a value indicative of the present loading of each transaction engine to the transaction switches.

10. The method of claim 8 wherein said each of said communication sessions is associated with a backup link to facilitate communications in the event of a failure.

11. The method of claim 10 wherein said assigning comprises assigning both a primary and a backup transaction engine.

12. The method of claim 8 wherein the assigning is accomplished in a round robin fashion.

13. Apparatus for processing multiple transactions, some of which require multiple accesses to databases, said apparatus comprising plural transaction engines for directly accessing the databases to perform said required multiple accesses, and a switching system for determining loading introduced by each transaction on a transaction engine to process said transaction, and for assigning said transactions in a manner based upon said loading.

14. The apparatus of claim 13 wherein said switching system is configured to attempt to balance the loading across multiple transaction engines in accordance with a predetermined criteria.

15. The apparatus of claim 14 wherein said predetermined criteria includes priority of transactions being processed.

16. The apparatus of claim 14 wherein said predetermined criteria includes volume of data to be entered or read out from a database.

17. The apparatus of claim 16 wherein each transaction engine is resident on a different computer.

18. The apparatus of claim 17 wherein the transaction engines communicate with each other via a local area network.

19. The apparatus of claim 17 wherein all communications between a transaction switch and a transaction engine are performed via backup up communications links.

20. Apparatus of claim 19 wherein at least one database has a synchronized backup and an archive backup that is not synchronized.
